(19) United States
(12) Patent Application Publication
(10) Pub. No.: US 2011/0271569 A1
(43) Pub. Date: Nov. 10, 2011

(54) DISPLAY WITH MULTI-FACETED ILLUMINATION EFFECT

(76) Inventors: Charles R. Nelson, Roebuck, SC (US); Tim G. Fallon, Lake Saint Louis, MO (US)

(21) Appl. No.: 12/777,115

(22) Filed: May 10, 2010

(51) Int. Cl. G09F 13/04; G09F 13/16

(52) U.S. Cl. 40/552; 40/541; 40/581; 40/582

(57) ABSTRACT

A display presenting a multi-faceted illumination effect includes a housing having an opening and a light source within the housing. A cover at least partially covers the opening of the housing and has a plurality of facets that are angled with respect to each other. One or more of the angles are formed such that facets abutting at the angles are visibly distinct to an observer outside the housing when illuminated by the light source within the housing to produce the multi-faceted illumination effect.

### FIELD

The present invention generally relates to electrified displays, and more particularly, to illuminated electrified displays.

### BACKGROUND

Illuminated signs are frequently used to advertise or convey a message to customers. Neon tubes, in particular, have been used for many years to provide signs that attract attention. The light emitted by a neon tube is attractive because it is uniformly distributed and brightly colored. However, neon tubes tend to consume large amounts of energy, generate heat, and have short lives, among other things. Therefore, other sources of light, such as light emitting diodes (LEDs), are often used to illuminate signs instead of neon tubes. However, other sources of light tend not to be as effective at distributing light uniformly or as brightly colored. A series of LEDs, for example, appear as a series of single points of light to an observer. Moreover, a large number LEDs may be required to simulate the brightness of a neon tube.

Developments in the field of illuminated signage have heretofore been focused on improving the ability of non-neon light sources to simulate light from neon tubes. However, a sign that simulates neon tube lighting can only be as eye-catching and appealing as a neon tube sign.

### SUMMARY

Embodiments of the present invention improve on the ability of illuminated electrified signs to attract an observer's attention. Embodiments described herein present a multi-faceted illumination effect, differing distinctly from and providing a more eye-catching appearance than the uniform illumination provided by a neon tube or other light source.

In a first example embodiment, a display presenting a multi-faceted illumination effect includes a housing having an opening and a light source within the housing. A cover at least partially covers the opening of the housing and has a plurality of facets that are angled with respect to each other. At least one pair of facets abut at an angle greater than 90 degrees as measured from the light source and are visibly distinct to an observer outside the housing when illuminated by the light source within the housing.

A second example embodiment is an illuminated display that includes a housing and a light source within the housing. The light source is configured to emit light through an opening in the housing. A cover at least partially covers the opening of the housing and has a plurality of facets that are angled with respect to each other. At least one angle formed on a side of the cover facing the light source and between abutting facets is greater than 180 degrees.

A third example embodiment is an illuminated display that includes a housing, a plurality of light sources within the housing, and a cover mounted to the housing. The housing has housing walls that form at least a portion of a representation. In addition, the housing walls fold inward so as to form raised lips and a channel enclosed within the housing walls. The light sources are disposed within the channel formed by the housing walls and the cover is mounted to the raised lips of the housing walls. Moreover, the cover has a plurality of facets arranged to direct light from the light sources in a plurality of directions corresponding to the plurality of facets.

The housing and cover can be configured so as to form at least a portion of a representation, such as a representation of a letter, a number, a feature of an object, and/or a graphic element.

Additional features of the invention will be set forth in the description which follows, and in part will be obvious from the description, or may be learned by the practice of the invention. The features of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a front perspective view of an example embodiment of an illuminated display depicting a representation;

FIG. 2 provides a peripheral perspective view of a word portion of the representation depicted by the example display of FIG. 1;

FIGS. 3A and 3B are, respectively, a cutaway perspective view and a cross-section perspective view of the word portion of the example display;

FIGS. 4A and 4B are, respectively, a cutaway perspective view and a cross-section perspective view of a border portion of the example display;

FIG. 5 is a cross-section perspective view of a first embodiment of a cover element in the word portion of the example display;

FIG. 6 is a cross-section perspective view of a first embodiment of a cover element in a border portion of the example display;

FIG. 7 is a cross-section perspective view of multiple alternative embodiments of the word cover element shown in FIG. 5; and

FIG. 8 is a cross-section perspective view of multiple alternative embodiments of the border cover element shown in FIG. 6.

### DETAILED DESCRIPTION

Reference will now be made to the figures wherein like structures will be provided with like reference designations. It is understood that the figures are diagrammatic and schematic representations of presently preferred embodiments of the invention, and are not limiting of the present invention, nor are they necessarily drawn to scale.

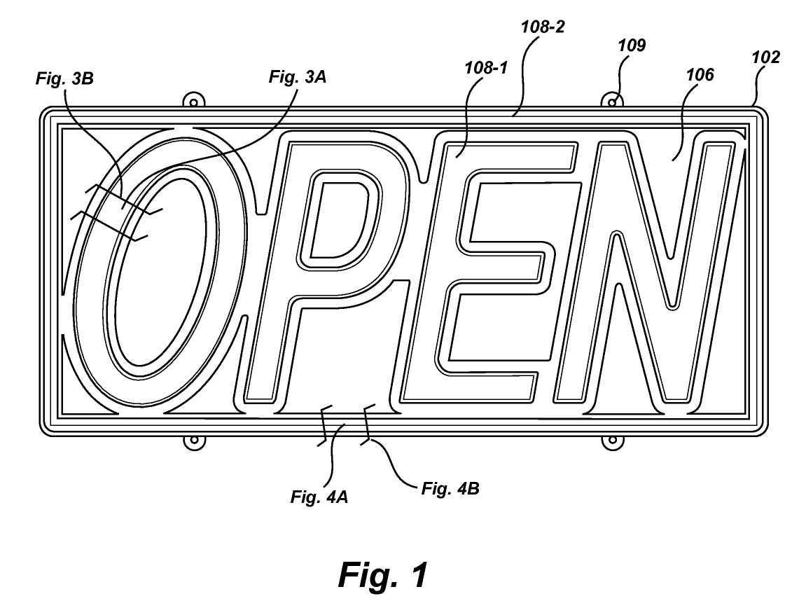

FIGS. 1-8 disclose various aspects of some example embodiments of the invention. Embodiments described herein may provide, among other things, illuminated displays having a multi-faceted illumination effect that is appealing and eye-catching. For example, a transparent or translucent cover for a light source may have multiple surfaces or facets that are angled with respect to each other. The angle between each facet may be obtuse but sharp enough to distinguish each facet from neighboring facets at least from an observer's point of view.

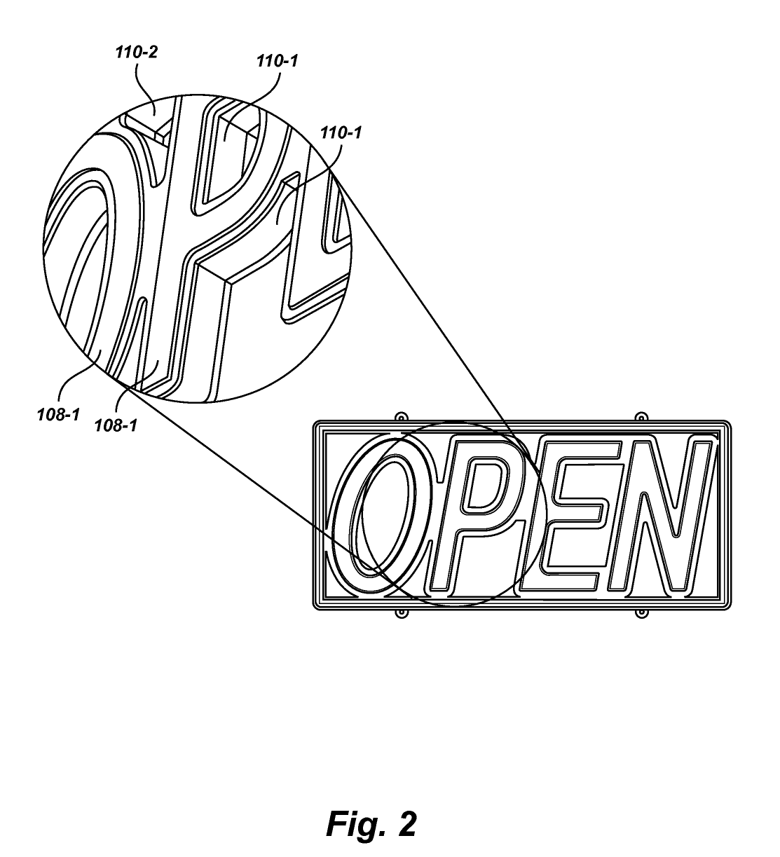

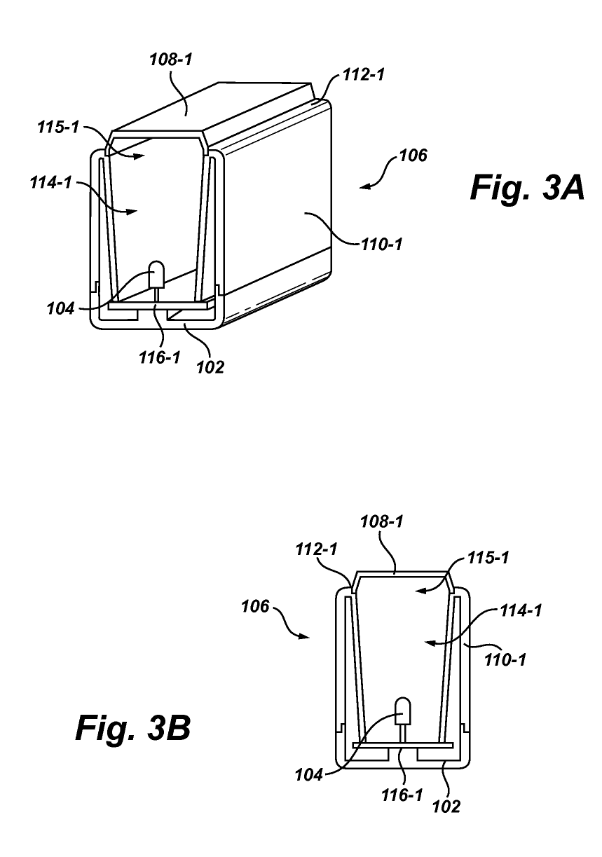

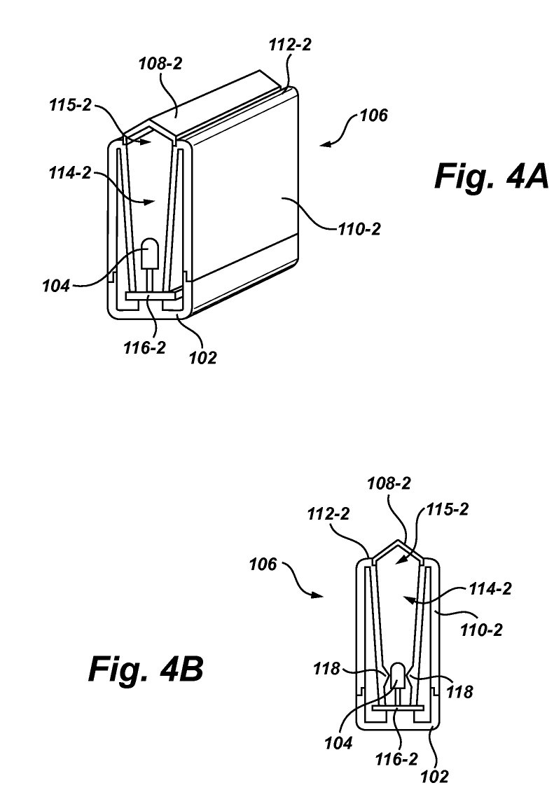

With reference to FIGS. 1-4, an example illuminated sign or display 100 is shown having unique multi-faceted characteristics. FIG. 1 depicts a front perspective view of display 100, while FIG. 2 depicts a peripheral perspective view of a portion of display 100, and FIGS. 3 and 4 depict cutaway perspective views and cross-section perspective views of display 100. Although display 100 depicts the word OPEN, it will be understood that other messages or representations, including alphabetical or numerical characters, symbols, graphic elements, features of an object, and/or images may be depicted by display 100.

As shown in FIGS. 1-4, display 100 includes a base member (also called a back plate) 102, one or more light sources 104 (not visible in FIGS. 1 and 2), a housing 106, and one or more lenses or covers 108-1 (corresponding to the word OPEN) and 108-2 (corresponding to a border around the word OPEN).

Housing 106, which houses light sources 104 within light source channels, is mounted on back plate 102. Housing 106 may be mounted on back plate 102 by a variety of means including, for example, screws, adhesive, and/or interference fit. In addition, covers 108 are mounted on the light source channels of housing 106 by similar means. Housing 106 and/or back plate 102 has protrusions 109 in which holes are pre-drilled to accommodate insertion of a screw used to mount display 100 to a wall or the like. Moldable plastic materials including, e.g, acrylonitrile butadiene styrene (ABS) or acrylic, may be injected into injection molds to form back plate 102, housing 106, and covers 108. Back plate 102, light sources 104, housing 106, and covers 108, as well as their positional relationship with respect to each other, are most easily visible in the cutaway and cross-section perspective views of FIGS. 3 and 4.

As shown in FIGS. 2, 3A, and 3B, housing 106 includes walls 110-1 that extend from back plate 102 when display 100 is in an assembled configuration. Walls 110-1 and other associated elements of display 100 are patterned to depict a representation, such as the word OPEN, or a portion of a representation. In contrast, walls 110-2 and its associated elements featured in FIGS. 4A and 4B—described in more detail below—are patterned to depict a border around the representation.

As depicted in FIGS. 3A and 3B, walls 110-1 fold inward toward each other and down toward back plate 102 to form raised lips 112-1, on which cover 108-1 is mounted, and a first truncated v-shaped channel 114-1. Thus, walls 110-1 form an opening 115-1 that extends between raised lips 112-1 and that is at least partially covered by cover 108-1.

Moreover, as depicted in FIGS. 3A and 3B, light sources 104 are housed within first channel 114-1 and are electrically connected to a printed circuit board (PCB) 116-1, which is mounted to back plate 102 by any suitable means, such as screws and/or adhesive. Moreover, PCB 116-1 is shaped to fit within first channel 114-1. Therefore, PCB 116-1 is shaped—along with opening 115-1, cover 108-1, and a portion of base 102 that supports walls 110-1—in the same pattern as first channel 114-1 formed by walls 110-1 to depict the representation (e.g., the word OPEN) or a portion thereof.

Light sources 104 may be a single light source or a plurality of point light sources. In embodiments using a plurality of point light sources, light sources 104 may be evenly spaced apart. Alternatively, to create a more uniform illumination effect to an observer, the point light sources may be randomly positioned with random pitch. In addition, light sources 104 may be any suitable light source including, for example, incandescent bulbs, LEDs, or a neon tube. Light sources 104 may be mounted by a soldered connection to electrical traces on PCB 116-1 and may provide substantially white light or a colored light, such as green, red, blue, purple, orange, yellow, etc. Furthermore, different light sources may be of different colors.

In the embodiments shown in the drawings, back plate 102 is formed separately from housing 106 to facilitate installation of PCB 116-1 and light sources 104 into display 100. For example, PCB 116-1 may be formed of a rigid material, such as an FR-4 laminate with conductive traces embedded therein, and may therefore be attached to back plate 102, along with light sources 104, before attaching housing 106 to back plate 102. However, in certain embodiments, back plate 102 and housing 106 may instead be one integral element. For example, if display 100 depicts a simple representation, such as a straight line, PCB 116-1 may be inserted through an open end of a housing that integrates housing 106 with back plate 102 as single piece. Alternatively, PCB 116-1 may be omitted and light sources 104 may be implemented as a flexible string of lights threaded through first channel 114-1 and secured to the integral housing at distal ends of first channel 114-1.

As shown in FIGS. 4A and 4B, housing 106 may also include walls 110-2, which are similar in configuration to walls 110-1. For example, like walls 110-1, walls 110-2 extend from back plate 102 in the assembled configuration of display 100. Moreover, as depicted in FIGS. 4A and 4B, walls 110-2 fold inward toward each other and down toward back plate 102 to form raised lips 112-2, an opening 115-2, and a second truncated v-shaped channel 114-2. Also, as depicted in FIGS. 4A and 4B, light sources 104 are mounted on a PCB 116-2 similar to PCB 116-1 and are housed within second channel 114-2.

Second channel 114-2 and its associated elements (walls 110-2, cover 108-2, opening 115-2, PCB 116-2, and a portion of base 102 that supports walls 110-2) may differ from the corresponding elements of FIGS. 3A and 3B, however, in that they are patterned to depict a border around the representation. Moreover, each of second channel 114-2 formed by walls 110-2, cover 108-2, opening 115-2, PCB 116-2, and the supporting portion of base 102 may be narrower than its corresponding element shown in FIGS. 3A and 3B. As a result, the representation may be visibly distinguished from its border by the distinct widths of each channel and its associated elements.

Due to the relative narrowness of second channel 114-2, it can be difficult to position light sources 104 into second channel 114-2 during installation. Therefore, to aid guidance of light sources 104 into second channel 114-2 during installation, nibs 118 (depicted in FIG. 4B) are formed proximate light sources 104 on inner sides of the walls forming second channel 114-2. For example, nibs 118 run along a lower portion of each inner wall, as shown in FIG. 4B.

In an alternative embodiment, walls 110-1 and 110-2, which form channels 114-1 and 114-2, are spaced to form channels of various different widths. For example, channels 114-1 and 114-2 may have substantially the same width or second channel 114-2 may be wider than first channel 114-1. In addition, one or both of channels 114-1 and 114-2 may be of a non-uniform width. For example, to show emphasis on a particular character, word, or image, first channel 114-1 may depict one or more character(s) or image(s) of a representation with a narrow width relative to the depiction of other character(s) or image(s). Associated elements, such as covers 108 over openings 115 and PCBs 116, may also be sized to accommodate the various different channel widths described above.

Embodiments are also contemplated in which a height of the walls that form each channel differs. For example a height of walls 110-2 forming second channel 114-2, corresponding to the border, may be greater than a height of walls 110-1 forming first channel 114-1, corresponding to the representation within the border. Alternatively, walls of one or both channels may be of varying or non-uniform heights.

As mentioned above, plastic materials, such as ABS or acrylic, are used in an injection molding process to form back plate 102, housing 106, and covers 108. Moreover, many different combinations of illumination effects may be achieved with display 100 by varying the materials used for back plate 102, housing 106, and covers 108. For example, any one of or all of back plate 102, housing 106, and covers 108 may be formed with opaque, translucent, or transparent material. Moreover, the materials used to form any one of or all of back plate 102, housing 106, and covers 108 may be colored so as to transmit light of a predetermined color. Additionally, a frosted or textured finish may be added to any surface, inner or outer, of back plate 102, housing 106, or covers 108.

In one embodiment, back plate 102 and housing 106 are formed of black ABS having a hair-cell textured finish on one or more surfaces. For example, outer surfaces (i.e., surfaces facing away from light sources 104) of back plate (102), covers 108, and walls 110, may have a hair-cell textured finish, while inner surfaces (i.e., surfaces facing toward light sources 104) of channels 114 may have a hair-cell textured finish. The hair-cell textured finish reduces visibility of scratches that may occur during shipping and handling.

In another embodiment, all or a portion of back plate 102 and/or housing 106 may be formed of transparent or translucent plastic. As a result, light from light sources 104 may be visible from peripheral and/or negative angles of observation with respect to a front perspective view of display 100. Moreover, portions that are made of translucent plastic including, e.g., channels 114-1 and 114-2, walls 110-1 and 110-2, and/or back plate 102, may have a frosted surface to diffuse light that is transmitted.

One or both of channels 114-1 and 114-2 may also be at least partially reflective so that a portion of light from light sources 104 is reflected toward covers 108-1 and/or 108-2 while another portion of light is transmitted through the channel(s) and through walls 110-1 and 110-2 (and optionally through back plate 102) at a peripheral and/or negative angle of observation. Furthermore, select portions of back plate 102 and housing 106 may be transparent while other select portions may be translucent. In addition, select portions of back plate 102 and housing 106 may be of a first color while other select portions may be of a second color to achieve an eye-catching multi-colored illumination effect.

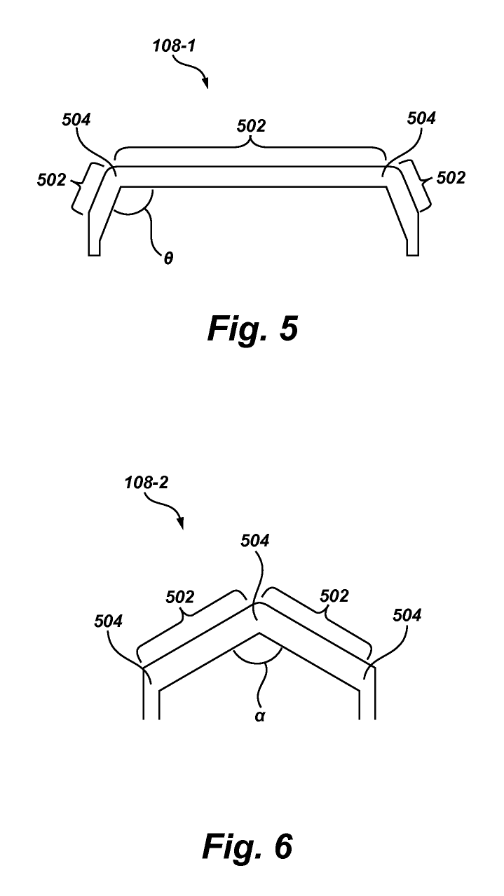

With reference now to FIGS. 5-8, cross-section perspective views of various embodiments of covers 108 are shown. FIG. 5 shows an example embodiment of cover 108-1 (corresponding to a representation) and FIG. 6 shows an example embodiment of a cover 108-2 (corresponding to a border around the representation). Covers 108-1 and 108-2 each include facets 502 that are angled with respect to each other and abut at vertices 504 interposed therebetween. Facets 502 are transparent or translucent to light emitted from light sources 104. Accordingly, the light is guided by facets 502 in different directions such that each facet 502 is visibly distinct to an observer. Moreover, the light may be diffused by a frosted inner and/or outer surface on one or more facets 502.

An obtuse angle θ internal to cover 108-1 (i.e., facing light sources 104) is formed between abutting facets and an obtuse internal angle a internal to cover 108-2 is formed between abutting facets. Although internal angles θ and α are obtuse, they are also sharp enough that the abutting facets are visibly distinct to an observer when light is transmitted through each facet. For example, angles θ and α may range between about 90 degrees and about 170 degrees.

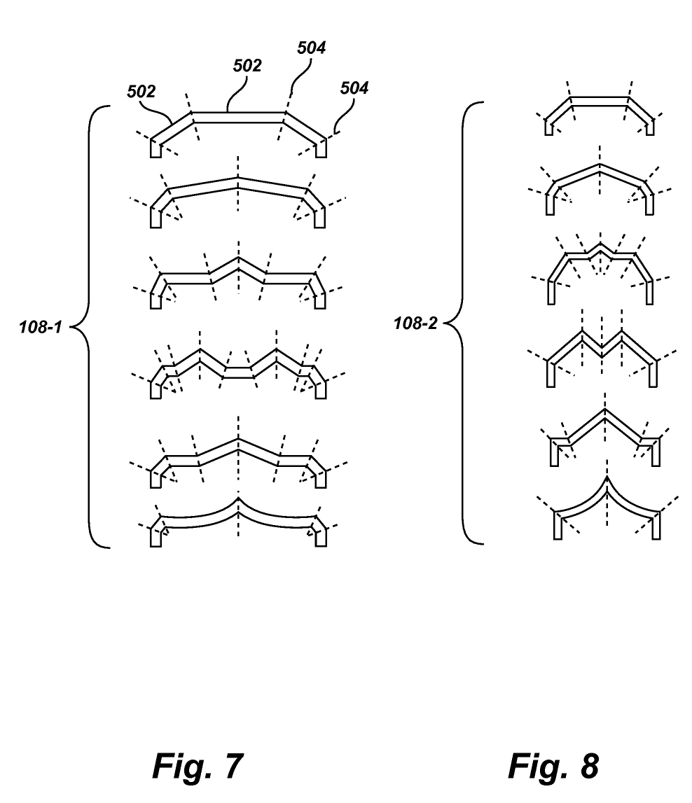

In embodiments of covers 108 having a non-wavy pattern (i.e., all internal angles are less than 180 degrees) the number of facets 502 may be limited to fewer than eight, thereby avoiding the appearance of a rounded or tubular light source. As shown in FIGS. 7 and 8, however, a variety of alternative embodiments of covers 108-1 and 108-2 are possible. For example, some alternative embodiments of the covers have a wavy pattern in which one or more internal angles are reflex angles, i.e., greater than 180 degrees. Consequently, valleys and peaks may be formed at vertices 504 (indicated by dashed lines in FIGS. 7 and 8) of covers 108-1 and 108-2.

The present invention may be embodied in other specific forms without departing from its spirit or essential characteristics. For example, although embodiments are described above in which back plate 102 and housing 106 are opaque while covers 108 are transparent or translucent, an opposite arrangement is also contemplated in which back plate 102 and/or housing 106, or portions thereof, are transparent or translucent while covers 108 are opaque. Therefore, the described embodiments are to be considered in all respects only as illustrative and not restrictive. Moreover, the scope of the invention is indicated by the appended claims rather than by the foregoing description. All changes which come within the meaning and range of equivalency of the claims are to be embraced within their scope.

What is claimed is:

1. A display presenting a multi-faceted illumination effect, the display comprising:
a housing having an opening;
a light source within the housing; and
a cover capable of transmitting light, the cover at least partially covering the opening of the housing and having a plurality of facets that are angled with respect to each other,
at least one pair of facets abutting at an angle greater than 90 degrees as measured from the light source,
the at least one pair of facets being visibly distinct to an observer outside the housing when illuminated by the light source within the housing.

2. The display as recited in claim 1, wherein the number of facets is fewer than eight.

3. The display as recited in claim 1, wherein at least a portion of at least one of:
the cover; and
the housing,
is translucent.

4. The display as recited in claim 1, wherein at least a portion of at least one of:
the cover; and
the housing,
is transparent.

5. The display as recited in claim 1, wherein at least a portion of at least one of:
the cover; and
the housing,
has a textured surface that diffuses light.

6. The display as recited in claim 1, wherein at least a portion of at least one of:
the cover; and
the housing,
is colored so as to transmit light of a predetermined color.

7. The display as recited in claim 1, wherein the light source is capable of emitting colored light.

8. The display as recited in claim 1, further comprising:
a base member that supports the housing and the light source.

9. The display as recited in claim 8, wherein at least a portion of the base member is at least one of:
translucent;
transparent;
textured on a surface thereof so as to diffuse light; and
colored so as to transmit colored light.

10. The display as recited in claim 8, further comprising:
a printed circuit board mounted to the base member, the light source being electrically connected to the printed circuit board.

11. The display as recited in claim 1, wherein the housing walls fold into the channel so as to form raised lips.

12. The display as recited in claim 1, wherein the housing and the cover are configured so as to form at least a portion of a representation of one of:
a letter;
a number;
a feature of an object; and
a graphic element.

13. The display as recited in claim 1, wherein the angle greater than 90 degrees is an obtuse angle.

14. The display as recited in claim 1, wherein the angle greater than 90 degrees is a reflex angle.

15. An illuminated display comprising:
a housing;
a light source within the housing, the light source being configured to emit light through an opening in the housing; and
a cover at least partially covering the opening of the housing and having a plurality of facets that are angled with respect to each other,
at least one pair of facets abutting at an angle greater than 180 as measured from the light source,
the at least one pair of facets being visibly distinct to an observer outside the housing when illuminated by the light source within the housing.

16. An illuminated display comprising:
a housing having housing walls, the housing walls folding inward so as to form raised lips and a channel enclosed within the housing walls;
a plurality of light sources disposed within the channel formed by the housing walls; and
a cover mounted to the raised lips of the housing walls, the cover having a plurality of facets arranged to direct light from the light sources in a plurality of directions corresponding to the plurality of facets,
the housing and the cover being configured so as to form at least a portion of a representation.

17. The illuminated display as recited in claim 16, wherein the representation at least partially formed by the housing walls and the cover is a representation of one of:
a letter;
a number;
a feature of an object; and
a graphic element.

18. The illuminated display as recited in claim 16, wherein the channel formed by the housing walls is at least partially translucent with respect to light emitted from the light sources.

19. The illuminated display as recited in claim 16, wherein the cover is at least partially translucent with respect to light emitted from the light sources.

20. The illuminated display as recited in claim 16, wherein the channel is formed in a truncated v-like shape that is wider at a first end proximal to the raised lips than at a second end distal to the raised lips.

21. The illuminated display as recited in claim 20, wherein a surface of the channel facing the light source is at least partially reflective with respect to the emitted light so as to reflect some light toward the cover.

22. The illuminated display as recited in claim 21, wherein the at least partially reflective surface is textured so as to diffuse reflected and transmitted light.
